(19) United States
(12) Patent Application Publication
(10) Pub. No.: US 2026/0015829 A1
(43) Pub. Date: Jan. 15, 2026

(54) METHOD FOR CONTROLLING OPERATION ON A SITE

(71) Applicant: Volvo Autonomous Solutions AB, GÖTEBORG (SE)

(72) Inventors: Oskar LJUNGKRANTZ, SÄRÖ (SE); Stefan BERGQUIST, GÖTEBORG (SE)

(21) Appl. No.: 19/231,644

(22) Filed: Jun. 9, 2025

(30) Foreign Application Priority Data
Jul. 10, 2024 (EP) 24187880.0

(51) Int. Cl. E02F 9/24; E02F 9/20

(52) U.S. Cl. CPC E02F 9/24; E02F 9/205; E02F 9/2054

(57) ABSTRACT

A computer system including processing circuitry being configured to be in a site operating mode for controlling the operation on a site including at least one automated vehicle and a site operator is provided. The processing circuitry is configured, in a site operating mode, to receive, from a requester, a restriction request, set the at least one automated vehicle in the restricted mode based on said restriction request, receive, from the requester, a resume request, in response to the resume request receive, from the site operator, a resume instruction, and set the at least one automated vehicle in a non-restricted mode at least based on the resume instruction.

### CROSS REFERENCE TO RELATED APPLICATIONS

This application claims priority to European Patent Application No. 24187880.0, filed on Jul. 10, 2024, the disclosure and content of which is incorporated by reference herein in its entirety.

### TECHNICAL FIELD

The disclosure relates generally to vehicles. In particular aspects, the disclosure relates to a method for controlling operation on a site. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Autonomously controlled vehicles used on a site may have different missions performing task at the site. On most sites, personnel are also present from time to time, either operating manually operating vehicles and/or inspecting the autonomously controlled vehicles. It is beneficial if the personnel is protected from the autonomously controlled vehicles in a safe but yet effective manner. Improvement of prior art systems are needed.

### SUMMARY

According to a first aspect of the disclosure, a computer system comprising processing circuitry being configured to be in a site operating mode for controlling the operation on a site, comprising at least one automated vehicle and a site operator, wherein the processing circuitry is configured, in a site operating mode, to: receive, from a requester, a restriction request; set the at least one automated vehicle in the restricted mode based on said restriction request, receive, from the requester, a resume request; in response to the resume request receive, from the site operator, a resume instruction; and set the at least one automated vehicle in a non-restricted mode at least based on the resume instruction. The first aspect of the disclosure may seck to provide a system that reduces the risk for personnel to be present in an area with autonomously controlled vehicles. A technical benefit may include an efficient yet safe control system where the workload on the site operator is reduced while still maintaining or increasing the safety at the site. A technical benefit may include that the site operator can for example take a lunch break without stopping all operations, by putting the site in a requester operation mode where no input from the site operator is needed. A further technical benefit may include that a manual operator, or other personnel, can leave the manual vehicle in a safe manner without being of the risk of getting run-over by one or more autonomously controlled vehicles.

In some embodiments, the processing circuitry is further configured to: receive an instruction, from the site operator, to operate in the requester operating mode or the site operating mode. A technical benefit may include an increased flexibility for the site operator. The site operator does not need to be present to restrict the operations and get it back to a non-restricted mode. Another technical benefit may be that the site system could be set in a requester mode in the morning and then not site operator is needed until closing down the site for the day. In one example, another technical benefit may be that the site operator does not need to close down the whole site if he/she needs a brake.

In some embodiments, the requester is an operator of at least one manually controlled vehicle or the site operator. A technical benefit may include an increased flexibility of the system.

In some embodiments, the restriction request comprises position data relating to a geographical area, and wherein the at least one automated vehicle is set in the restricted mode in said geographical area. A technical benefit may include an increased flexibility of the system.

In some embodiments, the resume request comprises position data relating to a geographical area, and wherein the at least one automated vehicle is set in the non-restricted mode in said geographical area. A technical benefit may include an increased flexibility of the system.

In some embodiments, the site comprises at least one manually controlled vehicle, and wherein the processing circuitry is further configured in the site operating mode to: set the at least one manually controlled vehicle in a restricted mode based on said restriction request; and set the at least one manually controlled vehicle in a non-restricted mode based on the resume instruction. A technical benefit may include an increased safety of the site.

In some embodiments, the processing circuitry is further configured in the site operating mode to: receive, from a first requester, a first restriction request; set the at least one automated vehicle in the restricted mode based on said first restriction request, receive, from a second requester, a second restriction request; set the at least one automated vehicle in the restricted mode based on said second restriction request, receive, from the first requester a, a first resume request; receive, from the second requester, a second resume request; in response to the second resume request receive, from the site operator, a resume instruction; and set the at least one automated vehicle in a non-restricted mode at least based on the second resume instruction.

In some embodiments, the processing circuitry is further configured in the site operating mode to: receive, from a first requester, a first restriction request; set the at least one automated vehicle in the restricted mode based on said first restriction request, receive, from a second requester, a second restriction request; set the at least one automated vehicle in the restricted mode based on said second restriction request, receive, from the first requester a, a first resume request; receive, from the second requester, a second resume request; in response to the second resume request receive, from the site operator, a resume instruction; and set the at least one automated vehicle in a non-restricted mode at least based on the first and second resume instruction.

In some embodiments, the processing circuitry is further configured in the requester operating mode to: receive, from a first requester, a first restriction request; set the at least one automated vehicle in the restricted mode based on said first restriction request, receive, from a second requester, a second restriction request; set the at least one automated vehicle in the restricted mode based on said second restriction request, receive, from the first requester a, a first resume request; receive, from the second requester, a second resume request; and set the at least one automated vehicle in a non-restricted mode at least based on the first and second resume request.

In some embodiments, the processing circuitry is further configured in the requester operating mode to: receive, from a first requester, a first restriction request; set the at least one automated vehicle in the restricted mode based on said first restriction request, receive, from a second requester, a second restriction request; set the at least one automated vehicle in the restricted mode based on said second restriction request, receive, from the first requester a, a first resume request; receive, from the second requester, a second resume request; and set the at least one automated vehicle in a non-restricted mode at least based on the second resume request.

In some embodiments, in the restricted mode; the operation of the vehicle; comprises at least one of reducing the speed of the vehicle, activating safety functions of the vehicle, stopping the operations of the vehicle.

In some embodiments, the site comprises a plurality of automated vehicles and wherein the processing circuitry is further configured to set all automated vehicle within an area of the site in a restricted mode, based on the restriction request.

According to a second aspect of the disclosure, a site comprising the computer system of the first aspect, wherein the site further comprises at least one automated vehicle and at least one site operator.

According to a third aspect of the disclosure, a computer-implemented method for controlling the operation on a site in a site operating mode, wherein the site comprises at least one automated vehicle and a site operator; wherein the method comprises, for the site operating mode: receive, by the processing circuitry, a restriction request from a requester; set, by the processing circuitry, the at least one automated vehicle in the restricted mode based on said restriction request, receive, by the processing circuitry, a resume request from the requester; in response to the resume request, receive, by the processing circuitry, a resume instruction from a site operator, and set, by the processing circuitry, the at least one automated vehicle in a non-restricted mode based on the resume instruction.

In some embodiments, further comprising, for a requester operating mode: receive, by the processing circuitry, a restriction request from a requester; set, by the processing circuitry, the at least one automated vehicle in the restricted mode based on said restriction request, receive, by the processing circuitry, a resume request from the requester; set, by the processing circuitry, the at least one automated vehicle in a non-restricted mode based on the resume request.

According to a fourth aspect of the disclosure, a computer program product comprising program code for performing, when executed by the processing circuitry, the method of the third aspect.

According to a fifth aspect of the disclosure, a non-transitory computer-readable storage medium comprising instructions, which when executed by the processing circuitry, cause the processing circuitry to perform the method of the third aspect.

The disclosed aspects, examples, and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIGS. 1A-C are exemplary views of a site according to examples.

FIG. 2 is an exemplary setup of a site according to an example.

FIG. 3 is an exemplary system diagram of functionality of a computer system according to one example.

FIGS. 4A-C are exemplary system diagrams of functionality of a computer system being in a requester operating mode according to examples.

FIGS. 5A-C are exemplary system diagrams of functionality of a computer system being in a site operating mode according to examples.

FIGS. 6A-B are flow charts of exemplary methods according to examples.

FIGS. 7A-B are flow charts of exemplary methods according to examples.

FIG. 8 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

In prior art solutions, if an operator needs to exit the area or the vehicle he/she needs to manually contact a site operator and ask that person to set the site in a safe state, which generally means that the activity is paused until the operator is back in a safe situation. The vehicle operator then manually contacts the site operator again, and the operator approves the resuming of operations. A similar situation arises when a person is entering an autonomous site.

The inventors of the present disclosure have insightfully realized that the safety at a site could be increased by at the same time reducing the workload on the site operator. In the present disclosure, each operator of a manually controlled vehicle can pause the operation at the site by not allowing operation, whereby the system puts the automated vehicles at the site, or part of a site, in a restricted mode. Depending on if the system is set in a first operating mode (requester operation mode) or a second operating mode (site operating mode), the automated vehicles are maintained in the restricted mode until a resume instruction and/or resume request to resume operation is received from either the requester or from both the requester and the site operator. The site operator can now for example take a lunch break without stopping all operations, by putting the site in a requester operation mode where no input from the site operator is needed.

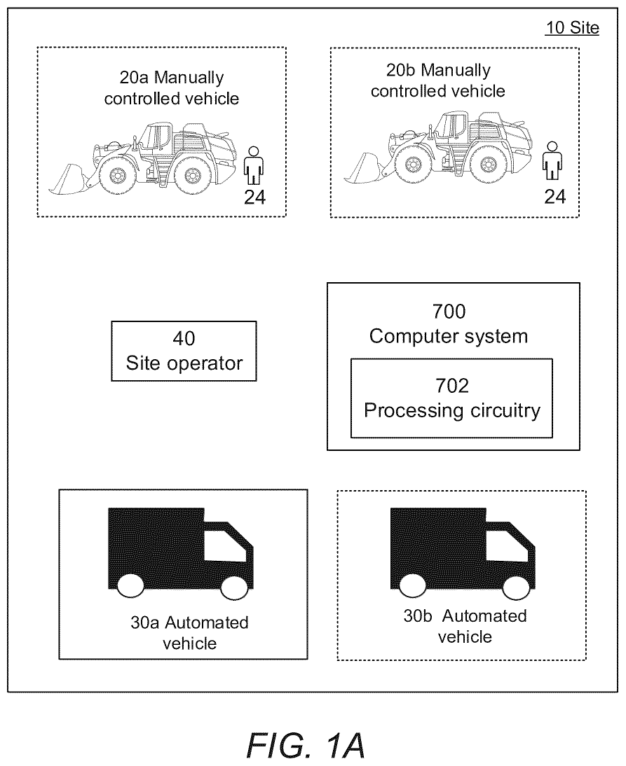

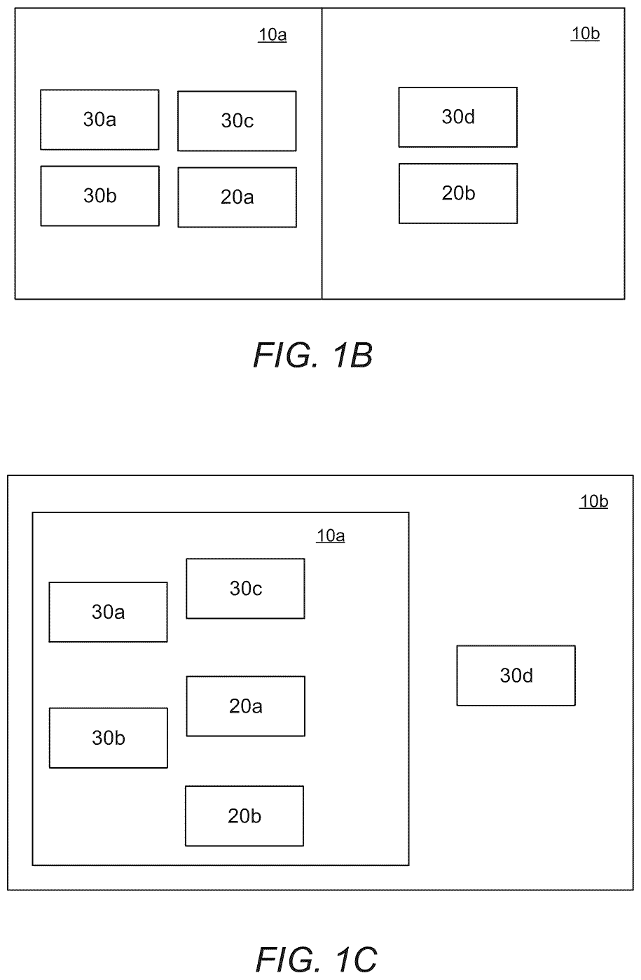

FIGS. 1A-C are exemplary illustration of a site 10 according to examples. The site 10 may be an area where a plurality of vehicles 20, 30 are operated. The site 10 may for example be a worksite, a machine hall, warehouse or distribution center.

The site may be a partly autonomous site, where manual vehicles are present in certain restricted areas of the site 10. As a non-limiting example, such areas may be loading/off-loading areas where workers/operator(s) at least partly handles work related to loading and/or off-loading load of vehicles.

In the example of FIG. 1A, the site 10 is arranged with at least one manual vehicle 20a, 20b and at least one automatic vehicle 30a, 30b. The vehicles may also be referred to as machines. The vehicles 20, 30 may be heavy machinery such as excavators, wheel loaders, hydraulic excavators, articulated haulers, haul truck, motor graders, soil and asphalt compactors, pavers, backhoe loaders, skid steers, milling machine, bulldozers, cranes and forklifts to mention a few.

The automatic vehicle 30 may for example be automated guided vehicles (AGVs) or autonomous mobile robots (ARMs). The manually controlled vehicles are at least in part manually controlled by an operator. The operator is a human worker at the site 10. The operator may also be referred to as a driver or a worker.

The site 10 further comprises a site operator 40. The site operator 40 may be a single user of the site or a group of users. The site operator 40 is responsible for the overall control of the vehicles and operators at the site 10 or parts of the site 10. The site operator 40 may be responsible for the vehicle operation, by ensuring that the vehicles are operated safely and according to the site's requirements. The site operator 40 may further be responsible for the overall site safety. The operator 40 may for example ensure that all operators are in compliance with safety regulations. The operator 40 may further be responsible for coordinating the operators and workers to ensure that the vehicles are used efficiently and effectively.

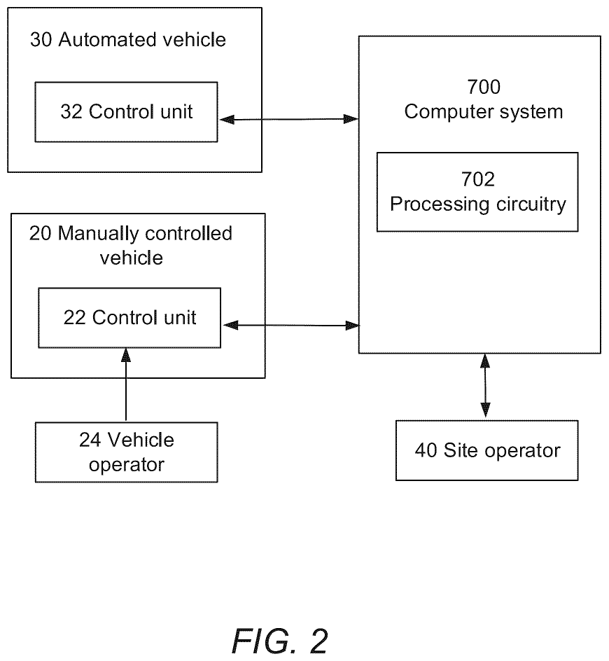

The site 10 is in operative communication with a computer system 700 comprising a processing circuitry 702. The computer system 700 is configured to control the operation of a site 10 and will be described more in detail with reference to FIGS. 2-8.

Turning to FIGS. 1B-C, the site 10 is divided into a plurality of sections or areas 10a, 10b. In one example, the size of the sections 10a, 10b are be fixed. In one example, the size of the sections 10a, 10b are adaptable. In one example, the number of sections are fixed. In one example, the number of sections are adaptable.

In one example, shown in FIG. 1B, the site 10 comprises five automated vehicles 30a-e and one manually controlled vehicle 20a. The site 10 comprises a first area 10a and a second area 10b. Three automated vehicles 30a-c and one manually controlled vehicle 20a is arranged in the first area 10a, and two automated vehicles 30d-e are arranged in the second area 10b. In this example, the size and number of sections are fixed.

In one example, as shown in FIG. 1C, the site 10 comprises four automated vehicles 30a-d and two manually controlled vehicles 20a-b. The site 10 comprises a first area 10a and a second area 10b. Three automated vehicles 30a-c and two manually controlled vehicles 20a-b is arranged in the first area 10a, and one automated vehicle 30d is arranged in the second area 10b. In this example, the size and number of sections are adaptable.

In one example the site 10 comprises a plurality of areas 10a, 10b. This may be seen as having a plurality of geographical zones. The geographical zones may be determined by position data. The position data may be received from one of the vehicles 20, 30.

FIG. 2 illustrates an example of the functionality of a computer system 700 having a processing circuitry 702 and an associated setup on a site 10. The site 10 comprises at least one automated vehicle 30 and at least one manually controlled vehicle 20. The automated vehicle 30 comprises a control unit 32. The manually controlled vehicle comprises a control unit 22. A vehicle operator 24 of the manually controlled vehicle 20 is configured to provide instructions to the control unit 22 of the vehicle 20. The control units 22, 32 of the vehicles 20, 30 are configured to communicate with the processing circuitry 702 of the computer system 700. In one example, the control units 22, 32 of the vehicles 20, 30 are configured to communicate with the computer system 700. The site operator 40 may be configured to provide instructions to the computer system 700.

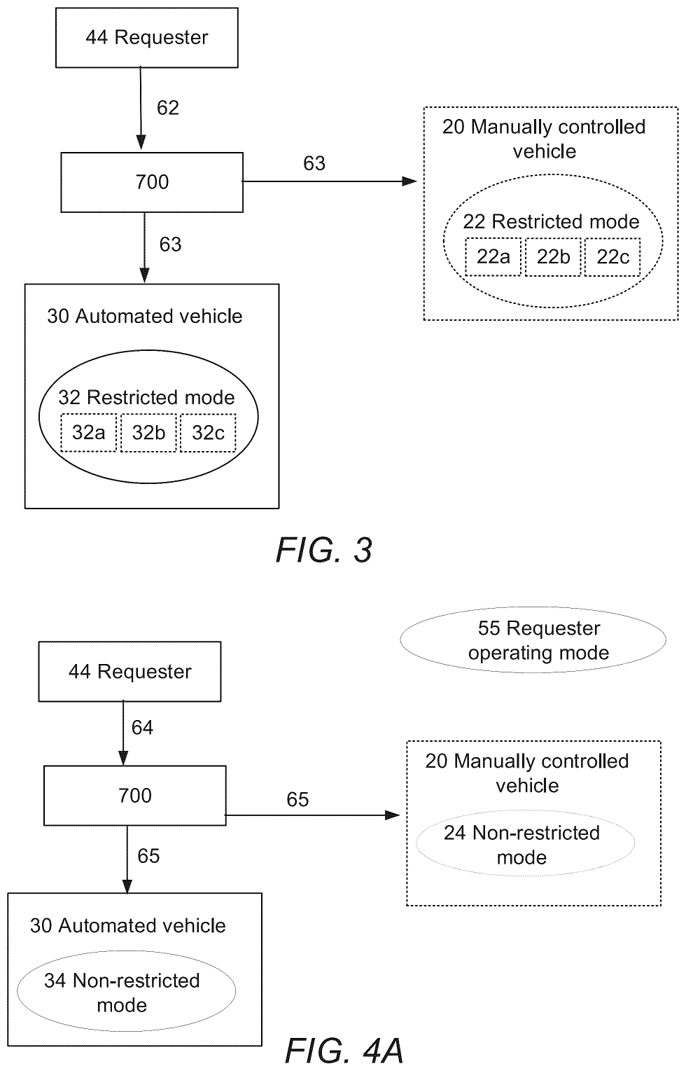

FIG. 3 illustrates the functionality of the computer system 700 once someone at the site 10 wants to put the vehicles of the site 10, or parts of the site 10, in a restricted mode 22, 32. That someone may be a vehicle operator 24 or the site operator 40. The person or persons that request that at least a part of the site 10 is to be put in a restricted mode 22, 32 is referred to as a requester 44. In other words, the requester 44 may be a vehicle operator of at least one manually controlled vehicle, or the site operator 40.

In one example, in the restricted mode 22, 32, the speed of the vehicle is reduced 22a, 32a (including a full stop), safety functions are activated 22b, 32b, and/or the operations of the vehicles are restricted 22c, 32c. The vehicle 20, 30 may be reduced to a low speed or reduced to be standing still. Safety functions may relate to sending out alarm sounds, activating alarm lamps, reducing speed, reducing possible operations and so on. Restricting vehicle operations may include stopping or restricting the speed, as well as stopping or restricting other functions of the vehicles, such as lifting functions etc.

Once the requester 44 has requested that at least all automatic vehicles 30 of at least a part of the site 10 is to be put in a restricted mode 22, 32, a restriction request 62 is transmitted. The restriction request 62 is transmitted to computer system 700. The computer system 700 is configured to put the automated vehicle(s) 30 in a restricted mode 32 based on the restriction request 62. This is may be made by transmitting a restriction instruction 63 to the vehicle(s). If the site further comprises a manually controlled vehicle, the computer system 700 may in some examples further be configured to put the manually controlled vehicle 20 in a restricted mode 22.

In one example, the requester 44 transmits a restriction request by manual input. If the requester is a vehicle operator 24, the manual input may be made on an input device in the vehicle the operator is operating. If the requester is a site operator 40, the manual input may be made on an input device on the site 10.

In one example, all at least all automated vehicles 20 of the site 10 are put in the restricted mode 22, 32 once a restriction request is transmitted to the computer system 700.

In one example, the restriction request 62 comprises positon data of the requester 44. The position data may relate to information of the geographical position of the requester 44. The geographical position may be x-y-coordinates. The geographical position may be retrieved from a positioning device. The positioning device may comprise Global positioning system (GPS), a light detection and ranging system (LiDAR), inertial navigation system (INS), real-Time Kinematics GPS, global navigation satellite system (GNSS), computer vision and/or ultra-Wideband (UWB). In one example, the positioning device is arranged on a vehicle of the requester (in the examples where the requester is a vehicle operator 24). In one example, the positioning device is arranged on a vehicle which is in operative communication with the site operator 40 (in the examples where the requester is the site operator 40).

In one example, the site 10 has a setup as described in relation to the example of FIG. 1B. In this example, the restriction request 62 comprises the geographical position of the requester 44. In this example, the requester 44 is the vehicle operator 25 of the first manually controlled vehicle 20a that is arranged in the first area 10a of the site 10. Once a restriction request 62 is transmitted to the computer system 700, the computer system 700 is configured to put at least all automated vehicle(s) in the first area 10a in a restricted mode 22, 32. In this example, the fourth automated vehicle 30d (and the second manually controlled vehicle 20b) are not put in a restricted mode, as they are arranged in a second area 10b of the site 10.

In one example, the site 10 has a setup as described in relation to the example of FIG. 1C. In this example, the restriction request 62 comprises the geographical position of the requester 44. Once a restriction request 62 is transmitted to the computer system 700, the computer system 700 is configured to put at least all automated vehicle(s) within a predetermined distance from the requester 44 in a restricted mode 22, 32. In this example, the requester 44 is the vehicle operator 25 of the first manually controlled vehicle 20a. The computer system 700 is thus configured to put at least all automated vehicles within a predetermined distance from the first manually controlled vehicle 20a in a restricted mode 22, 32. This area can be seen as a first area 10a of the site 10, where the area is adaptable. In this example, the fourth automated vehicle 30d is not put in a restricted mode, as it is far away from the requester 44. The fifth automated vehicle 30d can be seen as being in a second area 10b of the site 10, where the area is adaptable.

In one example, the computer system 700 is configured to determine position data of the requester 44 based on the restriction request 62 and set at least one automated vehicle 30 in the restricted mode 32 based on the position data. In one example, the computer system 700 is configured to determine position data of the requester 44 based on the restriction request 62 and set at least one manually controlled vehicle 20 in the restricted mode 22 based on the position data. In one example, the processing circuitry 700 of the computer system 700 is further configured to determine position data of the requester 44 based on the resume request 62, and use the position data when setting the vehicles 20, 30 in the non-restricted mode 24, 34 (as soon will be described more in detail).

The computer system 700 may be configured in different operating modes, where the different operating modes control how to put the vehicles 20, 30 in a non-restricted mode after being in the restricted mode 22, 32. The site may be arranged in a requester operating mode 55 and/or a site operating mode. In one example, the site operator 40 transmits instructions to the computer system 700 on which operating mode the site 10 should be operated in. In one example, the site operator 40 determines that the site 10 should be operated in a site operating mode during “normal operations”, for example when the site operator 40 is present at the site and controls the operation. In one example, the site operator 40 determines that the site 10 should be operated in a requester operating mode 55 when the site operator 40 is not present at the site. This may be temporarily, such as for a bathroom break or lunch break, or for a longer time period such as at specific time intervals such as during the night or weekends.

In one example, the computer system 700 is configured to determine if the site 10, or parts of the site 10, should be driven in a requester operating mode or a site operating mode. The computer system 700 may determine which operating mode that is to be activated based on time information. For example, the site operating mode may be used during normal working hours whereas the requester operating mode is to be used during other times where vehicles are operating at the site 10.

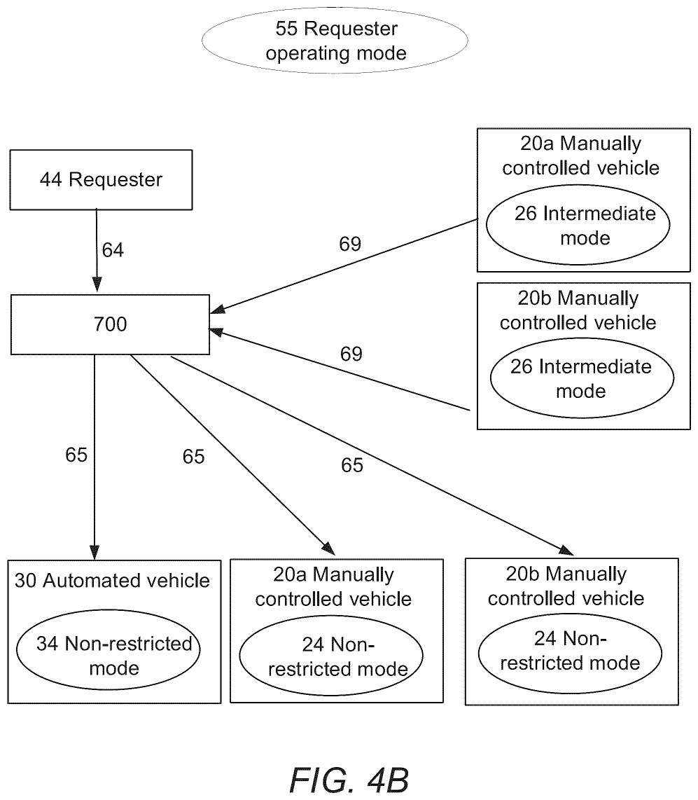

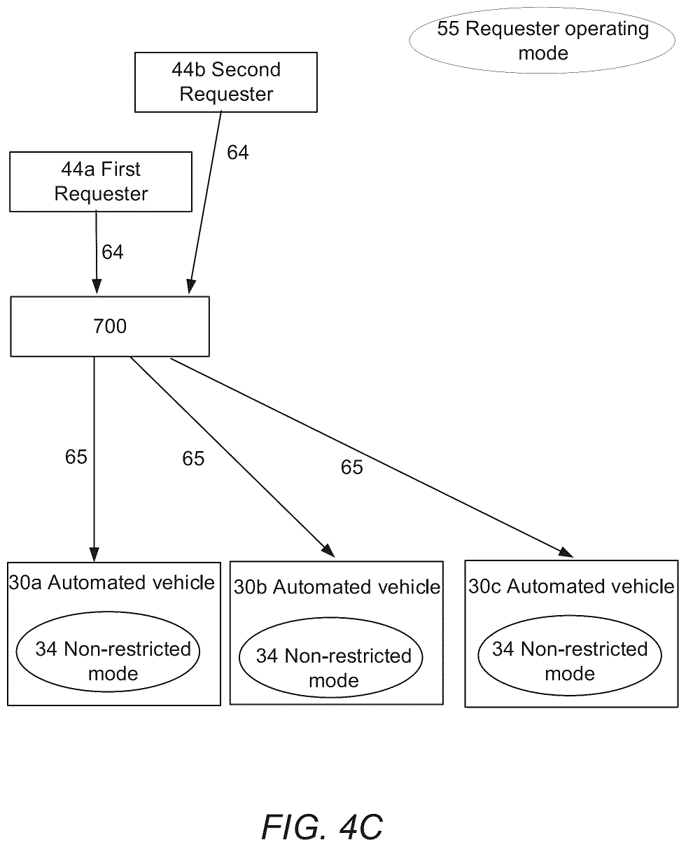

The computer system 700 may be configured to be arranged in a requester operating mode 55. Two examples of the requester operating mode 55 are illustrated in FIGS. 4A-C.

As illustrated in the example of FIG. 4A, in the requester operating mode 55, the computer system 700 is configured to receive a resume request 64. The resume request 64 is transmitted from the requester 44 that was previously transmitting the restriction request 62. The requester 44 is thus requesting the computer system 700 to resume operation by rescting the restriction request previously sent. This is typically the case if the requester 700, for example being a vehicle operator 25, is back in its vehicle again and want to resume work.

In one example, once the resume request 64 is received by the computer system 700, the at least one automated vehicle 30 is put in a non-restricted mode 34, 24. In one example, all vehicles 20, 30 of the site 10 are put in a non-restricted mode 34, 24. In one example, all vehicles that are in a restricted mode 23, 32 are put in a non-restricted mode 34, 24. In one example, all vehicles that are in a restricted mode 23, 32 within a predetermined area are put in a non-restricted mode 34, 24. In one example, all vehicles that are in a restricted mode 23, 32 within a predetermined distance from the requester 44 are put in a non-restricted mode 34, 24. In one example, only all automated vehicles are put in a non-restricted mode. As should be understood, the example above can be combined.

In one example, as illustrated in FIG. 4B, the computer system 700 is configured to obtain information 69 if the manually controlled vehicle(s) 20 at a site 10 are in an intermediate mode. In on example, this information 69 is obtained once a resume request 64 is received. In one example, this information 69 is obtained at a predetermined time interval. If all manually controlled vehicle(s) 20 at a site 10, or part of a site 10, are in an intermediate mode, the computer system 700 transmits an instruction 65 to put the vehicles in a non-restricted mode 34, 24. In one example, the manually controlled vehicles 20 are configured to transmit signals with the mode information 69 as a heart-beat signal. In other words, the signal with mode information 69 may be transmitted with a predetermined time interval. The time interval may be very short.

In one example, as illustrated in FIG. 4B, the site 10 comprises at least one automated vehicle 30, at least a first manually controlled vehicle 20a and at least a second manually controlled vehicle 20b, and the computer system 700 is configured to be arranged in a requester operating mode 55. The computer system 700 is configured to receive state information 69 from the first manually controlled vehicle 20a and state information 69 from the second manually controlled vehicle 20b. The computer system 700 is configured to set the vehicles 30, 20a, 20b in the non-restricted mode 24, 34 once a resume request is received and when all manually controlled vehicles 20a, 20b are in an intermediate mode. If one of the manually controlled vehicles 20a are not in an intermediate mode, the vehicle(s) will not be set in a non-restricted mode 34.

In one example, a manually controlled vehicles 20a is in an intermediate mode if no restriction request has been transmitted by the operator 25 of the vehicle. In one example, a manually controlled vehicles 20a is in an intermediate mode if the vehicle is not in a restricted mode 22.

Turning to FIG. 4C, a further example is shown. In the requester operating mode the computer system 700 is configured to receive a restriction request 62 to set the at least one automated vehicle 30 in the restricted mode 32. The system 700 further receives a restriction request 62 from a second requester 44b to set the at least one automated vehicle 30 in the restricted mode 32. The first requester 44a may for example be the operator of a first manual vehicle 20a and the second requester 44b may for example be the operator of a second manual vehicle 20a. In one example, the first requester 44a is an operator of a manual vehicle 20a and the second requester 44b is another worker at the site. In this example the computer system 700 is in a requester operator mode 55. The computer system 700 is further configured to receive, from the first requester 44a, a resume request 64. If the second requester 44b have not yet made a resume request, the automated vehicle will not be put in a non-restricted mode. The computer system 700 is further configured to receive, from the second requester 44b, a resume request 64. Hence, now both requester has made a resume request. The computer system 700 is configured to, in response to the second resume request 64 set the at least one automated vehicle 30 in a non-restricted mode 34 at least based on the second resume instruction 68.

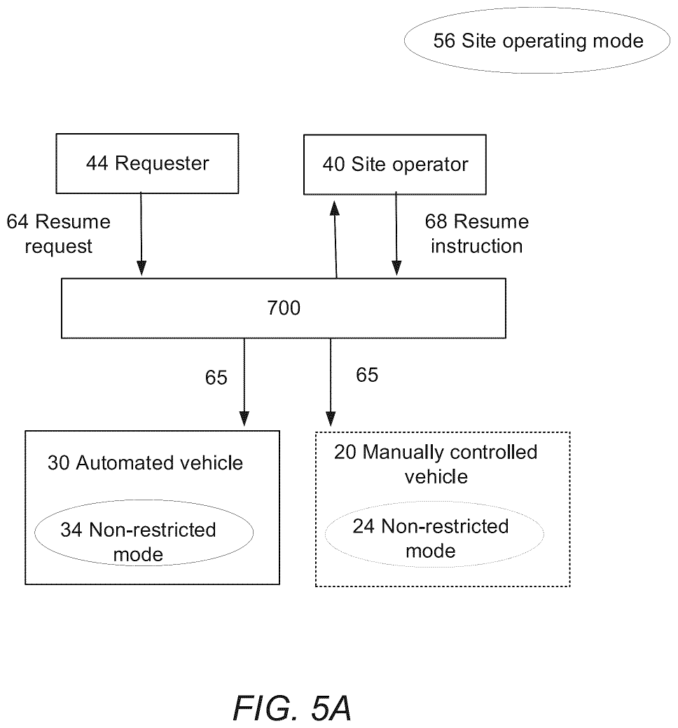

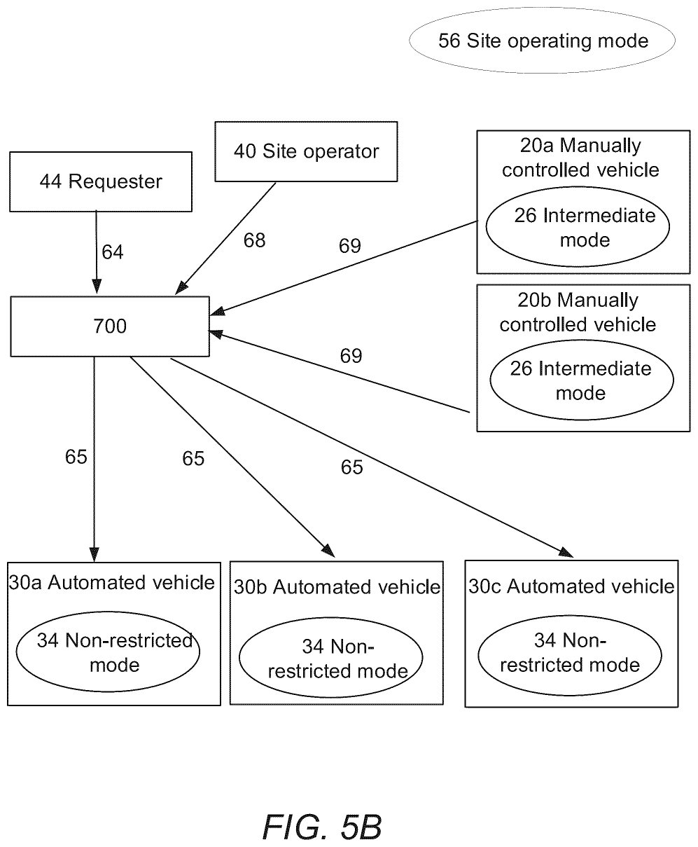

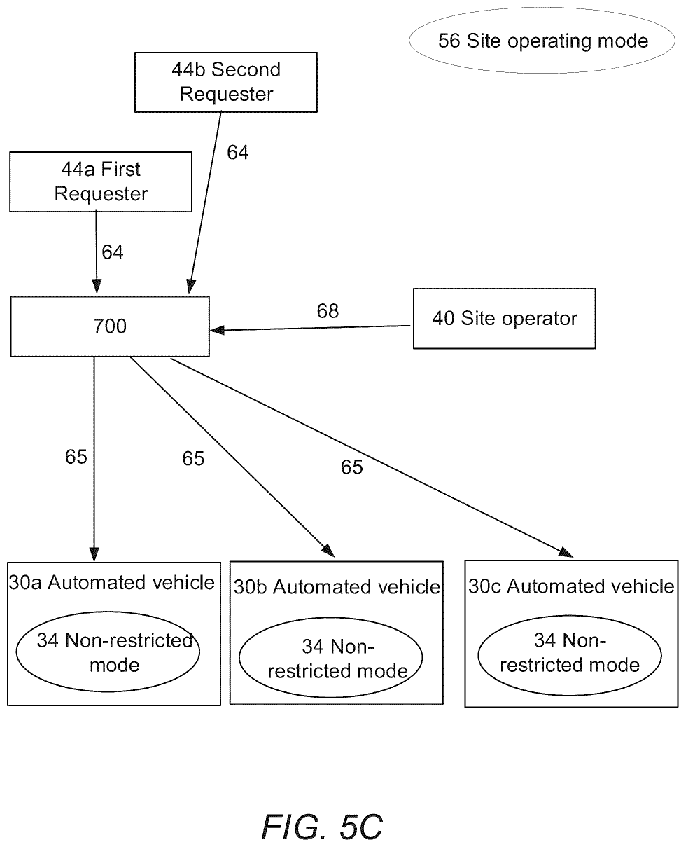

The computer system 700 is configured to be arranged in a site operating mode 56. Examples of the operation in a site operating mode is shown in FIGS. 5A-C. As is shown in FIG. 5A, in the site operating mode 56, the computer system is configured to receive a resume request 64. The resume request 64 is transmitted from the requester 44 that was previously transmitting the restriction request 62. The requester 44 is thus requesting the computer system 700 to resume operation, and thus reset the restriction request previously sent.

In the site operating mode 56, a resume request 44 from the requester is not sufficient to set the vehicles in a non-restricted mode. In this operating mode, the site operator 40 also needs to determine that the work is safe to be resumed and re-activated.

In one example, the computer system 700 receives the resume request 64 from the requester 44 and based on said request prompts the site operator 40 to transmit a resume instruction 68. The site operator 40 may transmit a resume instruction 68 by an input device arranged at the site 10. Once the computer system 700 receives the resume instruction 68, the computer system 700 instructs the vehicle(s) 20, 30 to be put in a non-restricted mode 24, 34.

In one example, a requester 44 sends a resume request 64 wishing to proceed operation. The resume request 64 is obtained by the computer system 700. The computer system 700 prompts the site operator 40 to send out a resume instruction 68 to the computer system 700. Once the computer system 700 receives the resume instruction 68, the computer system is configured to transmit instructions 65 to put the vehicles 20, 30 in a non-restricted mode 24, 34.

In one example of FIG. 5B, the computer system 700 is further configured to receive state information 69 from the manually controlled vehicle(s). The computer system 700 is configured to obtain information 69 if the manually controlled vehicle(s) 20 at a site 10 are in an intermediate mode. In on example, this information 69 is obtained once a resume request 64 is received. In on example, this information 69 is obtained once a resume instruction 68 is received from the site operator 40. In one example, this information 69 is obtained at a predetermined time interval.

If all manually controlled vehicle(s) 20 at a site 10, or part of a site 10, are in an intermediate mode, the computer system 700 transmits an instruction 65 to put at least the automated vehicles in a non-restricted mode 34. In one example, the manually controlled vehicles 20 are configured to transmit signals with the mode information 69 as a heart-beat signal. In other words, the signal with mode information 69 may be transmitted with a predetermined time interval. The time interval may be very short.

Turning to FIG. 5C, a further example is shown. In the site operating mode the computer system 700 is configured to receive a restriction request 62 to set the at least one automated vehicle 30 in the restricted mode 32. The system 700 further receives a restriction request 62 from a second requester 44b to set the at least one automated vehicle 30 in the restricted mode 32. The first requester 44a may for example be the operator of a first manual vehicle 20a and the second requester 44b may for example be the operator of a second manual vehicle 20a. In one example, the first requester 44a is an operator of a manual vehicle 20a and the second requester 44b is another worker at the site.

The computer system 700 is further configured to receive, from the first requester 44a, a resume request 64. If the second requester 44b have not yet made a resume request, the automated vehicle will not be put in a non-restricted mode.

The computer system 700 is further configured to receive, from the second requester 44b, a resume request 64. Hence, now both requester has made a resume request. The computer system 700 is configured to, in response to the second resume request 64 receive, from the site operator 40, a resume instruction 68, and set the at least one automated vehicle 30 in a non-restricted mode 34 at least based on the second resume instruction 68.

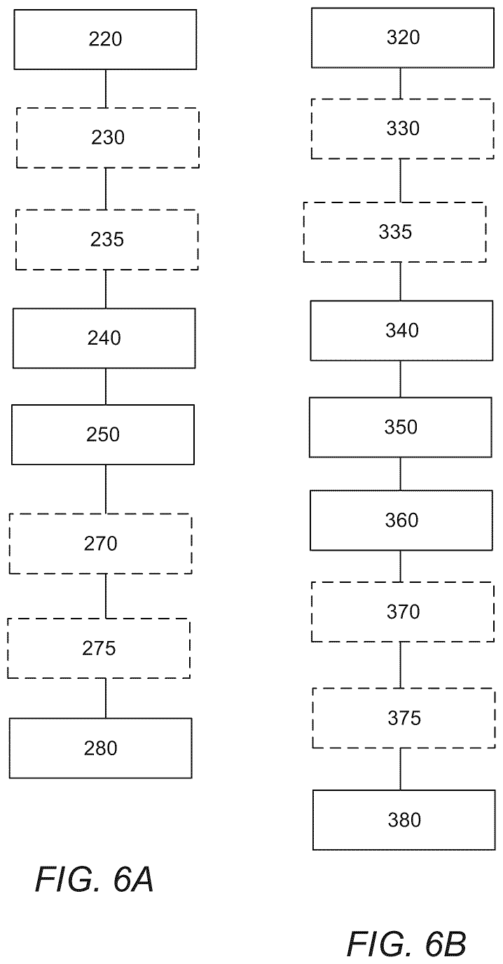

Schematic illustrations of examples of methods for controlling the operation on a site 10 is provided in FIGS. 6A-B.

The method of FIG. 6A illustrates an example of the system being in a requester operating mode. The method comprises receiving 220, from a requester 44, a restriction request 62. In one example, the method may further comprises determining 230 position data retrieved from the restriction request. In one example, the method may further comprise determining 235 a first area 10a of the site. The method further comprises setting 240 the at least one automated vehicle 30 in a restricted mode 32 based on said restriction request 62.

The method further comprises receiving 250, from the requester 44, a resume request 64. The computer system 700 is setting the vehicle 30 in a non-restricted mode 34 by transmitting an instruction to said vehicle based at least on the resume request. Hence, the method further comprises setting 280 the vehicle(s) in a non-restricted mode.

In one example, the method further comprises, before setting 280 the vehicle(s) in a non-restricted mode, receiving 270 state information 69 from the manually controlled vehicle(s) 20 at the site, or at a relevant part of the site 10. The method determines 275 whether all manually controlled vehicle(s) 20 at the site, or at a relevant part of the site 10 are in are in an intermediate mode based on the state information 69. Upon determining 275 that all manually controlled vehicle(s) 20 at the site, or at a relevant part of the site 10 are in are in an intermediate mode, the method further comprises setting 280 at least one automated vehicle 30 in a non-restricted mode 34. The instruction may be sent based on the resume request 64 in combination with the determination that all relevant manually controlled vehicle(s) 20 are in an intermediate mode.

A method of controlling a plurality of vehicles in a requester operating mode will now be described with relation to the example of the site in FIG. 1B. In this example, the requester 44 is the vehicle operator 25 of the first manually controlled vehicle 20a that is arranged in the first area 10a of the site 10. The method comprises receiving 220 a restriction request 62 from the requester 44. The method further comprises determining 230 position data retrieved from the restriction request. The method further comprises setting 240 the three automated vehicles 30a-c and, optionally the one manually controlled vehicle 20a, that is arranged in the first area 10a, in a restricted mode 32 based on said restriction request 62. In this example, only the vehicles arranged in the first area 10a are put in restricted mode. The method further comprises receiving 250, from the requester 44, a resume request 64. In one example, the method further comprises receiving 270 state information 69 from the one manually controlled vehicle 20a in the area 10a. The computer system 700 determines 275 whether all (in this example, only one) manually controlled vehicle(s) 20 at the area 10a of the site is in are in an intermediate mode based on the state information 69. Upon determining the manually controlled vehicle is in an intermediate mode, the method further comprises setting 280 the three automated vehicles 30a-c and the manually controlled vehicle 20a in a non-restricted mode 24, 34. The computer system 700 is setting the vehicles 20, 30 in a non-restricted mode 34 by transmitting instructions to all relevant vehicles.

A method of controlling a plurality of vehicles in a requester operating mode will now be described with relation to the example of the site in FIG. 1C. In this example, the requester 44 is the vehicle operator 25 of the first manually controlled vehicle 20a that is arranged in the first area 10a of the site 10. The method comprises receiving 220 a restriction request 62 from the requester 44. The method further comprises determining 230 position data retrieved from the restriction request. The method may further comprise determining 235 a first area 10a of the site. The determination may be based on the position data from the restriction request.

The method further comprises setting 240 the three automated vehicles 30a-c, and optionally the two manually controlled vehicles 20a, 20b, that is arranged in the first area 10a, in a restricted mode 32 based on said restriction request 62. In this example, only the vehicles arranged in the first area 10a are put in restricted mode. The method further comprises receiving 250, from the requester 44, a resume request 64. In one example, the method further comprises receiving 270 state information 69 from all manually controlled vehicles 20a, 20b in the area 10a. The computer system 700 determines 275 whether all (in this example, both) manually controlled vehicles 20a, 20b at the area 10a of the site is in are in an intermediate mode based on the state information 69. Upon determining that both the manually controlled vehicles are in an intermediate mode, the method further comprises setting 280 the three automated vehicles 30a-c and the two manually controlled vehicles 20a, 20b in a non-restricted mode 24, 34.

The method of FIG. 6B illustrates an example of the system being in a site operating mode 56. The method comprises receiving 320, from a requester 44, a restriction request 62. In one example, the method further comprises determining 330 position data retrieved from the restriction request. The method may further comprise determining 330a a first area 10a of the site. The method further comprises setting 340 the at least one automated vehicle 30 in a restricted mode 32 based on said restriction request 62.

The method further comprises receiving 350 a resume request 64 from the requester 44. The method further comprises receiving 360 a resume instruction 68 from a site operator 40. The resume instruction 68 may be received in response to the resume request 64. The method further comprises setting 380 the at least one automated vehicle 30 in a non-restricted mode 34 based at least one the resume instruction 68.

In one example, the method further comprises, before setting 380 the vehicle(s) in a non-restricted mode, receiving 370 state information 69 from the manually controlled vehicle(s) 20 at the site, or at a relevant part of the site 10. The method determines 375 whether all manually controlled vehicle(s) 20 at the site, or at a relevant part of the site 10 are in are in an intermediate mode based on the state information 69. Upon determining 375 that all manually controlled vehicle(s) 20 at the site, or at a relevant part of the site 10 are in are in an intermediate mode, the method further comprises setting 380 at least one automated vehicle 30 in a non-restricted mode 34. It should be noted that the step of receiving state information 69 may be performed before receiving a resume instruction 68 from the site operator 40.

A method of controlling a plurality of vehicles in a site operating mode will now be described with relation to the example of the site in FIG. 1B. In this example, the requester 44 is the vehicle operator 25 of the first manually controlled vehicle 20a that is arranged in the first area 10a of the site 10. The method comprises receiving 320 a restriction request 62 from the requester 44. The method further comprises determining 330 position data retrieved from the restriction request. The method further comprises setting 340 the three automated vehicles 30a-c and the one manually controlled vehicle 20a that is arranged in the first area 10a, in a restricted mode 32 based on said restriction request 62. In this example, only the vehicles arranged in the first area 10a are put in restricted mode. The method further comprises receiving 250, from the requester 44, a resume request 64. The method further comprises receiving 360 a resume instruction 68 from the site operator 40.

In one example, the method further comprises receiving 370 state information 69 from the one manually controlled vehicle 20a in the area 10a. The computer system 700 determines 370a whether all (in this example, only onc) manually controlled vehicle(s) 20 at the area 10a of the site is in are in an intermediate mode based on the state information 69. Upon determining the manually controlled vehicle is in an intermediate mode, the method further comprises setting 380 the three automated vehicles 30a-c and the manually controlled vehicle 20a in a non-restricted mode 24, 34. The computer system 700 is setting the vehicles 20, 30 in a non-restricted mode 34 by transmitting instructions to all relevant vehicles.

A method of controlling a plurality of vehicles in a site operating mode will now be described with relation to the example of the site in FIG. 1C. In this example, the requester 44 is the vehicle operator 25 of the first manually controlled vehicle 20a that is arranged in the first area 10a of the site 10. The method comprises receiving 320 a restriction request 62 from the requester 44. The method further comprises determining 330 position data retrieved from the restriction request. The method may further comprise determining 330a a first area 10a of the site. The determination may be based on the position data from the restriction request.

The method further comprises setting 340 the three automated vehicles 30a-c and the two manually controlled vehicles 20a, 20b that is arranged in the first area 10a, in a restricted mode 32 based on said restriction request 62. In this example, only the vehicles arranged in the first area 10a are put in restricted mode. The method further comprises receiving 250, from the requester 44, a resume request 64. The method further comprises receiving 360 a resume instruction 68 from the site operator 40. In one example, the method further comprises receiving 370 state information 69 from all manually controlled vehicles 20a, 20b in the area 10a. The computer system 700 determines 370a whether all (in this example, both) manually controlled vehicles 20a, 20b at the area 10a of the site is in are in an intermediate mode based on the state information 69. Upon determining that both the manually controlled vehicles are in an intermediate mode, the method further comprises setting 380 the three automated vehicles 30a-c and the two manually controlled vehicles 20a, 20b in a non-restricted mode 24, 34.

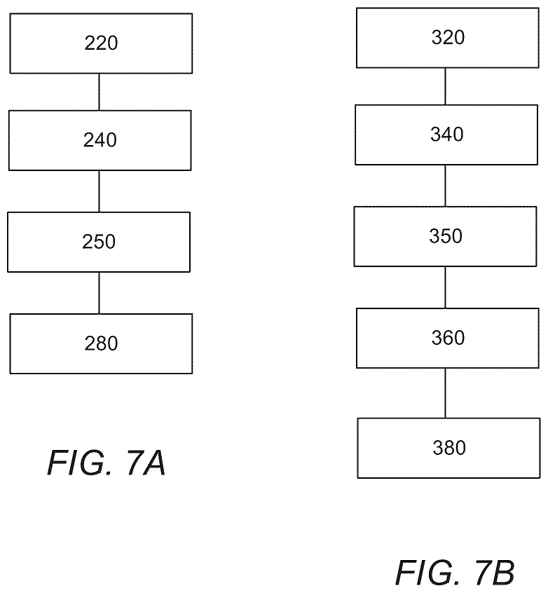

Schematic illustrations of methods for controlling the operation on a site 10 is provided in FIGS. 7A-B. The method of FIG. 7A illustrates an example of the system being in a requester operating mode. The method comprises receiving 220, from a requester 44, a restriction request 62 and setting 240 the at least one automated vehicle 30 in a restricted mode 32 based on said restriction request 62. The method further comprises receiving 250, from the requester 44, a resume request 64 and setting 280 the at least one automated vehicle 30 in a non-restricted mode 34 based on said resume request 64.

The method of FIG. 7B illustrates an example of the system being in a site operating mode. The method comprises receiving 320, by the processing circuitry, a restriction request 62 from a requester 44 and setting 340 by the processing circuitry, the at least one automated vehicle 30 in the restricted mode 32 based on said restriction request 62. The method further comprises receiving 350, by the processing circuitry, a resume request 64 from the requester 44. The method further comprises receiving 370, by the processing circuitry, a resume instruction 68 from a site operator 40. The resume instruction 68 may be received as a response to receiving the resume request 64. The method further comprises setting 380, by the processing circuitry, the at least one automated vehicle 30 in a non-restricted mode 34 based on the resume instruction 68.

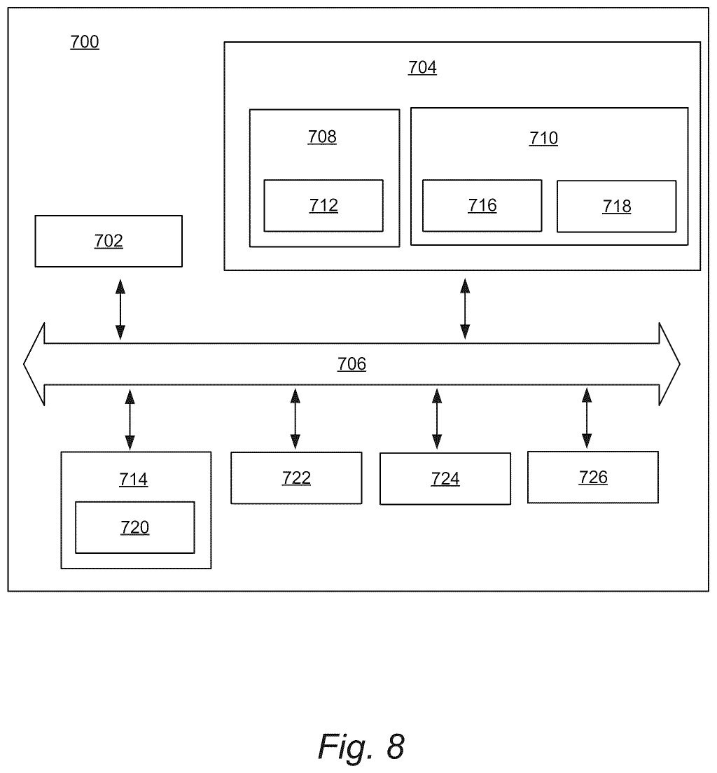

FIG. 8 is a schematic diagram of a computer system 700 for implementing examples disclosed hercin. The computer system 700 is adapted to execute instructions from a computer-readable medium to perform these and/or any of the functions or processing described herein. The computer system 700 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include processing circuitry 702 (e.g., processing circuitry including one or more processor devices or control units), a memory 704, and a system bus 706. The computer system 700 may include at least one computing device having the processing circuitry 702. The system bus 706 provides an interface for system components including, but not limited to, the memory 704 and the processing circuitry 702. The processing circuitry 702 may include any number of hardware components for conducting data or signal processing or for executing computer code stored in memory 704. The processing circuitry 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuitry 702. In some examples, the storage device 714 may be a computer program product (e.g., readable storage medium) storing the computer program 720 thercon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.
Example 1: A computer system 700 comprising processing circuitry 702 being configured to be in a site operating mode 56 for controlling the operation on a site 10; 10a, 10b comprising at least one automated vehicle 30 and a site operator 40, wherein the processing circuitry 702 is configured, in a site operating mode 56, to: receive, from a requester 44, a restriction request 62; set the at least one automated vehicle 30 in the restricted mode 32 based on said restriction request 62, receive, from the requester 44, a resume request 64; in response to the resume request 64 receive, from the site operator 40, a resume instruction 68; and set the at least one automated vehicle 30 in a non-restricted mode 34 at least based on the resume instruction 68.
Example 2: The computer system of example 1, wherein the processing circuitry 702 is further configured to be in a requester operating mode 55, wherein, in the requester operating mode 55, the processing circuitry 702 is configured to: receive, from a requester 44, a restriction request 62, set the at least one automated vehicle 30 in a restricted mode 32 based on said restriction request 62, receive, from the requester 44, a resume request 64; set the at least one automated vehicle 30 in a non-restricted mode 34 at least based on said resume request 64.
Example 3: The computer system of example 1 and 2, wherein the processing circuitry 702 is further configured to: receive an instruction, from the site operator 40, to operate in the requester operating mode 55 or the site operating mode 56.
Example 4: The computer system of any of examples 1-3, wherein the requester 44 is an operator of at least one manually controlled vehicle 20 or the site operator 40.
Example 5: The computer system of any of examples 1-4, wherein the restriction request comprises position data relating to a geographical area, and wherein the at least one automated vehicle 30 is set in the restricted mode 32 in said geographical area.
Example 6: The computer system of any of examples 1-5, wherein the resume request comprises position data relating to a geographical area, and wherein the at least one automated vehicle 30 is set in the non-restricted mode 34 in said geographical area.
Example 7: The computer system of any of examples 1-6, wherein the site 10 comprises at least one manually controlled vehicle 20, and wherein the processing circuitry 702 is further configured in the site operating mode to: set the at least one manually controlled vehicle 20 in a restricted mode 23 based on said restriction request 62; and set the at least one manually controlled vehicle 20 in a non-restricted mode 24 based on the resume instruction 68.
Example 8: The computer system of any of examples 1-7, wherein the processing circuitry 702 is further configured in the site operating mode to: receive, from a first requester 44a a restriction request 62; set the at least one automated vehicle 30 in the restricted mode 32 based on said first restriction request 62, receive, from a second requester 44b a restriction request 62; set the at least one automated vehicle 30 in the restricted mode 32 based on said second restriction request 62, receive, from the first requester 44a, a resume request 64; receive, from the second requester 44b, a resume request 64; in response to the second resume request 64 receive, from the site operator 40, a resume instruction 68; and set the at least one automated vehicle 30 in a non-restricted mode 34 at least based on the second resume instruction 68.
Example 9: The computer system of any of examples 1-8, wherein in the restricted mode 22; 32 the operation of the vehicle 20; 30 comprises at least one of reducing the speed of the vehicle 20; 30, activating safety functions of the vehicle 20; 30, stopping the operations of the vehicle 20; 30.
Example 10: The computer system of any of examples 1-9, wherein the site 10 comprises a plurality of automated vehicles 30a-d and wherein the processing circuitry 702 is further configured to set all automated vehicles 30a-d within an area of the site 10 in a restricted mode 22, 32 based on the restriction request 62.
Example 11: A site 10 comprising the computer system of any of examples 1-10, wherein the site further comprises at least one automated vehicle 30 and at least one site operator 40.
Example 12: A computer-implemented method for controlling the operation on a site 10 in a site operating mode 56, wherein the site 10 comprises at least one automated vehicle 30 and a site operator 40; wherein the method comprises, for the site operating mode 56: receive 320, by the processing circuitry, a restriction request 62 from a requester 44; set 340, by the processing circuitry, the at least one automated vehicle 30 in the restricted mode 32 based on said restriction request 62, receive 350, by the processing circuitry, a resume request 64 from the requester 44; in response to the resume request 64, receive 360, by the processing circuitry, a resume instruction 68 from a site operator 40, and set 380, by the processing circuitry, the at least one automated vehicle 30 in a non-restricted mode 34 based on the resume instruction 68.
Example 13: The method according to example 12, further comprising, for a requester operating mode 55: receive 220, by the processing circuitry, a restriction request 62 from a requester 44; set 240, by the processing circuitry, the at least one automated vehicle 30 in the restricted mode 32 based on said restriction request 62, receive 250, by the processing circuitry, a resume request 64 from the requester 44; set 280, by the processing circuitry, the at least one automated vehicle 30 in a non-restricted mode 34 based on the resume request 64.
Example 14: A computer program product comprising program code for performing, when executed by the processing circuitry 702, the method of example 12.
Example 15: A non-transitory computer-readable storage medium comprising instructions, which when executed by the processing circuitry 702, cause the processing circuitry to perform the method of example 12.
Example 16: The computer system of any of examples 1-10, wherein the site 10 comprises a plurality of automated vehicles 30a-d and a plurality of manually controlled vehicles 20a-c and wherein the processing circuitry 702 is further configured to set all automated vehicles 30a-d and all and all manually controlled vehicles 20a-c within an area of the site 10 in a restricted mode 22, 32 based on the restriction request 62.
Example 17: The computer system of any of examples 1-10 or 16, wherein the processing circuitry 702 is further configured to: determine that the computer system is to operate in the requester operating mode 55 or the site operating mode 56.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to be in a site operating mode for controlling the operation on a site comprising at least one automated vehicle and a site operator,
wherein the processing circuitry is configured, in a site operating mode, to:
receive, from a requester, a restriction request;
set the at least one automated vehicle in the restricted mode based on said restriction request,
receive, from the requester, a resume request;
in response to the resume request receive, from the site operator, a resume instruction; and
set the at least one automated vehicle in a non-restricted mode at least based on the resume instruction.

2. The computer system of claim 1, wherein the processing circuitry is further configured to be in a requester operating mode, wherein, in the requester operating mode, the processing circuitry is configured to:
receive, from a requester, a restriction request,
set the at least one automated vehicle in a restricted mode based on said restriction request,
receive, from the requester, a resume request;
set the at least one automated vehicle in a non-restricted mode at least based on said resume request.

3. The computer system of claim 1, wherein the processing circuitry is further configured to:
receive an instruction, from the site operator, to operate in the requester operating mode or the site operating mode.

4. The computer system of claim 1, wherein the requester is an operator of at least one manually controlled vehicle or the site operator.

5. The computer system of claim 1, wherein the restriction request comprises position data relating to a geographical area, and wherein the at least one automated vehicle is set in the restricted mode in said geographical area.

6. The computer system of claim 1, wherein the resume request comprises position data relating to a geographical area, and wherein the at least one automated vehicle is set in the non-restricted mode in said geographical area.

7. The computer system of claim 1, wherein the site comprises at least one manually controlled vehicle, and wherein the processing circuitry is further configured in the site operating mode to:
set the at least one manually controlled vehicle in a restricted mode based on said restriction request; and
set the at least one manually controlled vehicle in a non-restricted mode based on the resume instruction.

8. The computer system of claim 1, wherein the processing circuitry is further configured in the site operating mode to:
receive, from a first requester, a first restriction request;
set the at least one automated vehicle in the restricted mode based on said first restriction request,
receive, from a second requester, a second restriction request;
set the at least one automated vehicle in the restricted mode based on said second restriction request,
receive, from the first requester, a first resume request;
receive, from the second requester, a second resume request;
in response to the second resume request receive, from the site operator, a resume instruction; and
set the at least one automated vehicle in a non-restricted mode at least based on the second resume instruction.

9. The computer system of claim 1, wherein in the restricted mode the operation of the vehicle comprises at least one of reducing the speed of the vehicle, activating safety functions of the vehicle, stopping the operations of the vehicle.

10. The computer system of claim 1, wherein the site comprises a plurality of automated vehicles and wherein the processing circuitry is further configured to set all automated vehicles within an area of the site in a restricted mode based on the restriction request.

11. The computer system of claim 1, wherein the site comprises a plurality of automated vehicles and a plurality of manually controlled vehicles and wherein the processing circuitry is further configured to set all automated vehicles and all and all manually controlled vehicles within an area of the site in a restricted mode based on the restriction request.

12. The computer system of claim 1, wherein the processing circuitry is further configured to: determine that the computer system is to operate in the requester operating mode or the site operating mode.

13. A site comprising the computer system of claim 1, wherein the site further comprises at least one automated vehicle and at least one site operator, and wherein the site further comprises a plurality of automated vehicles and a plurality of manually controlled vehicles.

14. A site comprising the computer system of claim 13, wherein the site further comprises a plurality of automated vehicles and a plurality of manually controlled vehicles.

15. A computer-implemented method for controlling the operation on a site in a site operating mode, wherein the site comprises at least one automated vehicle and a site operator; wherein the method comprises, for the site operating mode:
receive, by the processing circuitry, a restriction request from a requester;
set, by the processing circuitry, the at least one automated vehicle in the restricted mode based on said restriction request,
receive, by the processing circuitry, a resume request from the requester;
in response to the resume request, receive, by the processing circuitry, a resume instruction from a site operator, and
set, by the processing circuitry, the at least one automated vehicle in a non-restricted mode based on the resume instruction, wherein the site further comprises a plurality of automated vehicles and a plurality of manually controlled vehicles and wherein the processing circuitry is further configured to set all automated vehicles and all manually controlled vehicles within an area of the site in a restricted mode based on the restriction request.

16. The method according to claim 15, further comprising, for a requester operating mode:
receive, by the processing circuitry, a restriction request from a requester;
set, by the processing circuitry, the at least one automated vehicle in the restricted mode based on said restriction request,
receive, by the processing circuitry, a resume request from the requester;
set, by the processing circuitry, the at least one automated vehicle in a non-restricted mode based on the resume request, wherein the processing circuitry is further configured to: determine that the computer system is to operate in the requester operating mode or the site operating mode.

17. A computer program product comprising program code for performing, when executed by the processing circuitry, the method of claim 15.

18. A non-transitory computer-readable storage medium comprising instructions, which when executed by the processing circuitry, cause the processing circuitry to perform the method of claim 15.
